(19) United States
(12) Patent Application Publication
(10) Pub. No.: US 2013/0127784 A1
(43) Pub. Date: May 23, 2013

(54) METHODS AND APPARATUSES FOR HIDING OPTICAL CONTRAST FEATURES

(71) Applicant: Russel Allyn Martin, Menlo Park, CA (US)

(72) Inventor: Russel Allyn Martin, Menlo Park, CA (US)

(73) Assignee: QUALCOMM MEMS Technologies, Inc., San Diego, CA (US)

(21) Appl. No.: 13/302,384

(22) Filed: Nov. 22, 2011

(51) Int. Cl. G06F 3/042; G09G 5/10; H01S 4/00; G02B 5/00

(52) U.S. Cl. 345/175; 359/893; 345/690; 29/825

(57) ABSTRACT

This disclosure provides systems, methods, and apparatuses for hiding optical contrast features. To reduce visibility of an elongated optical contrast feature, such as a wire on a transparent light guide, neighboring light-turning features in the light guide are “moved” relative to their location in a layout where they are physically uniformly distributed. This movement renders the local optical density in the region around the wire more equal to the optical density in other regions of the light guide. The movement of neighboring light-turning features occurs principally within a distance from the wire that is within the width of the line spread function of the human eye at a normal viewing distance. The uniformity of the local optical density is therefore increased, and the human eye does not perceive the wires as being separate structures. Thus, the wires can be “hidden” within a field of light-turning features.

### TECHNICAL FIELD

This disclosure relates to illumination systems, including illumination systems for displays, particularly illumination systems having light guides with light-turning features, and to electromechanical systems.

### DESCRIPTION OF THE RELATED TECHNOLOGY

Electromechanical systems (EMS) include devices having electrical and mechanical elements, actuators, transducers, sensors, optical components (such as mirrors and optical film layers) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Reflected ambient light is used to form images in some display devices, such as those using pixels formed by interferometric modulators. The perceived brightness of these displays depends upon the amount of light that is reflected towards a viewer. In low ambient light conditions, light from an artificial light source is used to illuminate the reflective pixels, which then reflect the light towards a viewer to generate an image. To meet market demands and design criteria, new illumination devices are continually being developed to meet the needs of display devices, including reflective and transmissive displays.

### SUMMARY OF THE INVENTION

The systems, methods and devices of the disclosure each have several innovative aspects, no single one of which is solely responsible for the desirable attributes disclosed herein. One innovative aspect of the subject matter described in this disclosure can be implemented in a device that includes a substrate assembly. The substrate assembly includes an elongated optical contrast feature on a substrate, a first region immediately adjacent the elongated optical contrast feature, and a second region immediately adjacent the first region, and further from the elongated optical contrast feature than the first region. A first plurality of discrete optical contrast features is distributed in the first region, and a second plurality of discrete optical contrast features is distributed in the second region. The density of discrete optical contrast features is lower in the first region than in the second region. In some implementations, a boundary between the first region and the second region is spaced from the elongated optical contrast feature at a substantially uniform distance along its length. In certain implementations, the first region can fall substantially entirely within the line spread function of the elongated optical contrast feature for a human eye at a distance of approximately 16 inches. In some implementations, the elongated optical contrast feature can be a wire. In other implementations, the substrate can be a light guide and the discrete optical contrast features include light-turning features configured to turn light propagating within the light guide such that the turned light exits the light guide through a bottom major surface of the light guide to a display.

Another innovative aspect of the subject matter described herein can be implemented in a device that includes a substrate assembly. The substrate assembly includes an elongated optical contrast feature on a substrate, and means for obscuring the elongated optical contrast feature. In certain implementations, the means for obscuring the elongated optical contrast feature can include a first region centered around the elongated optical contrast feature, and a second region, immediately adjacent the first region and further from the elongated optical contrast feature than the first region. The density of discrete optical contrast features can be lower in the first region than in the second region. In some implementations, the elongated optical contrast feature can be a wire electrically connected to a touch sensor system configured to sense the proximity of a conductive body. In some other implementations, the discrete optical contrast features can be recesses formed in the substrate. In certain implementations, the recesses can be metalized. In some implementations, the first region can fall within the line spread function of the elongated optical contrast feature for a human eye at a distance of approximately 16 inches.

Another innovative aspect of the subject matter of the present disclosure can be implemented in a method of manufacturing a device, the method including providing a substrate, providing an elongated optical contrast feature on the substrate, providing a first plurality of discrete optical contrast features in a first region of the substrate immediately adjacent the elongated optical contrast feature, and providing a second plurality of discrete optical contrast features in a second region of the substrate immediately adjacent the first region and further from the elongated optical contrast feature than the first region. The discrete optical contrast features are provided such that the first density of the first plurality of discrete optical contrast features is lower than a second density of the second plurality of discrete optical contrast features. In some implementations, providing the elongated optical contrast feature can include forming a wire on the substrate. In other implementations, providing the discrete optical contrast features can include forming recesses on a top surface of the substrate. In certain implementations, the recesses may be coated with metal. In some implementations, the first region may fall within the line spread function of the elongated optical contrast feature for a human eye at a distance of approximately 16 inches.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9A is an example of an illustration of a display being illuminated by an illumination device.

FIG. 9B is an example of an illustration of a display with an illumination device and a touch sensor.

FIG. 9C is an example of an illustration of a display with an integrated illumination device with touch sensor.

FIG. 10A is an example of an illustration of a light guide.

FIG. 10B is an example of an illustration of a light guide with metalized light-turning features.

FIG. 10C is an example of a cross-sectional view of a light guide with metalized light-turning features with integrated touch sensor.

FIG. 10D is an example of an illustration of a cross-sectional view of a light guide with metalized light-turning features and touch-sensing electrodes.

FIG. 11 is an example of an illustration of a touch sensor.

FIGS. 12A and 12B are examples of illustrations of light guides with light-turning features with integrated touch sensors.

FIGS. 13A and 13B are examples of illustrations of the degradation of visual stimuli due to the optics of the human eye.

FIG. 14 shows a graph of the contrast sensitivity function for the human eye.

FIGS. 15A and 15B show examples of illustrations of a portion of a light guide with light-turning features and a conductor.

FIG. 15C shows an example of an illustration of the line spread functions associated with the light guide shown in FIGS. 15A and 15B.

FIGS. 16A and 16B show examples of illustrations of a portion of a light guide with light-turning features overlapping with a conductor.

FIG. 16C shows an example of an illustration of the line spread functions associated with the light guide shown in FIGS. 16A and 16B.

FIGS. 17A and 17B show examples of illustrations of a plan view of a portion of a light guide with a conductor surrounded by light-turning features.

FIGS. 18A and 18B show examples of a plan view of a portion of a light guide with a conductor surrounded by light-turning features and dummy light-turning features.

FIG. 19 shows an example of a flow diagram illustrating a method of arranging optical contrast features on a substrate.

FIG. 20 shows an example of a flow diagram illustrating a method for designing the arrangement of light-turning features and dummy light-turning features on a substrate.

FIGS. 21A and 21B show examples of system block diagrams illustrating a display device that includes a plurality of interferometric modulators.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (for example, video) or stationary (for example, still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (for example, e-readers), computer monitors, auto displays (for example, odometer and speedometer displays, etc.), cockpit controls and/or displays, camera view displays (for example, display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (for example, display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various implementations disclosed herein relate to methods and apparatuses for hiding optical contrast features. An optical contrast feature may be any object that provides a visual contrast compared to its local background. For example, against a light surface or background, a dark or opaque feature may be considered an optical contrast feature. Conversely, against a dark surface or background, a light feature may be considered an optical contrast feature. Optical contrast features may be formed by the presence and/or absence of material. Optical contrast features may be elongated, or discrete (for example, rotationally symmetrical, as viewed in plan view) and relatively small in comparison to the elongate features. Some optical contrast features may be described as “discrete” in comparison to “elongate” features in the sense that a plurality of the discrete features can be overlaid on the elongate features without overlapping those discrete features. Due to imperfections in the human eye, each optical contrast feature can appear to an observer to be “smeared out” over a larger area than it physically occupies. This effect can be characterized by the line spread function of each optical contrast feature. By taking advantage of these imperfections in the human eye, certain arrangements of discrete optical contrast features can decrease visibility of elongate optical contrast features. In a field of roughly uniformly distributed discrete optical contrast features, an elongated optical contrast feature may be visible to a viewer, even if the individual discrete optical contrast features are not. To reduce visibility of the elongated optical contrast features, neighboring discrete optical contrast features are “moved” (relative to a roughly uniform distribution of discrete optical contrast features) such that the density of discrete optical contrast features is lower in a region immediately adjacent the elongated optical contrast feature than in the regions further from the elongated optical contrast feature. This movement of the discrete optical contrast features can provide a more uniform optical density over the entire area, thereby rendering the elongated optical contrast features less apparent to an observer.

As one example, in the case of a light guide and integrated touch screen for a frontlight illumination system, light-turning features such as metalized light-turning features can constitute the discrete optical contrast features, while touch-sensing wires or electrodes can constitute the elongated optical contrast features. The light-turning features may be roughly uniformly distributed over the surface of the light guide, and are typically invisible to an observer. The wires, however, may be visible under certain viewing conditions. To reduce the visibility of these wires, neighboring light-turning features are “moved” relative to their location in a layout in which they are roughly physically uniformly distributed, and formed on the wires to make the local optical density around the wires closer to the optical density in other regions of the light guide. The movement of neighboring light-turning features occurs principally within a distance from the wire that falls within the width of the line spread function of the human eye at a normal viewing distance (for example, 16 inches). Due to the increased uniformity of the optical density, the human eye does not perceive the wires as being separate structures and, thus, the wires can be “hidden.”

Particular implementations of the subject matter described in this disclosure can be implemented to realize one or more of the following potential advantages. For example, the structures and methods disclosed herein can be employed to reduce visibility of elongated optical contrast features, such as wires distributed over a light guide. Touch screens typically use a plurality of wires arranged in a grid overlying the display. It is desirable to reduce visibility of such wires as much as possible, so as not to interfere with displayed images. The wires may be disposed on a surface with discrete optical contrast features, such as light-turning features. Arranging the discrete optical contrast features as disclosed herein can be used to reduce visibility of the elongated optical contrast features, thereby improving the perceived image quality of the display. For example, the improvement in the image quality can be due to the reduction of the visibility of the wires. This can be achieved while still allowing the wires to be opaque and does not require them to be so narrow as to be invisible to a human observer. Such a narrow wire would be difficult to fabricate and would not provide a strong capacitive signal, while the relatively wide lines allowed by some implementations herein are more easily fabricated and allow a stronger capacitive signal in implementations where the lines are used as electrodes in a capacitive touch screen.

One example of a suitable MEMS or electromechanical systems (EMS) device, to which the described methods and implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity. One way of changing the optical resonant cavity is by changing the position of the reflector.

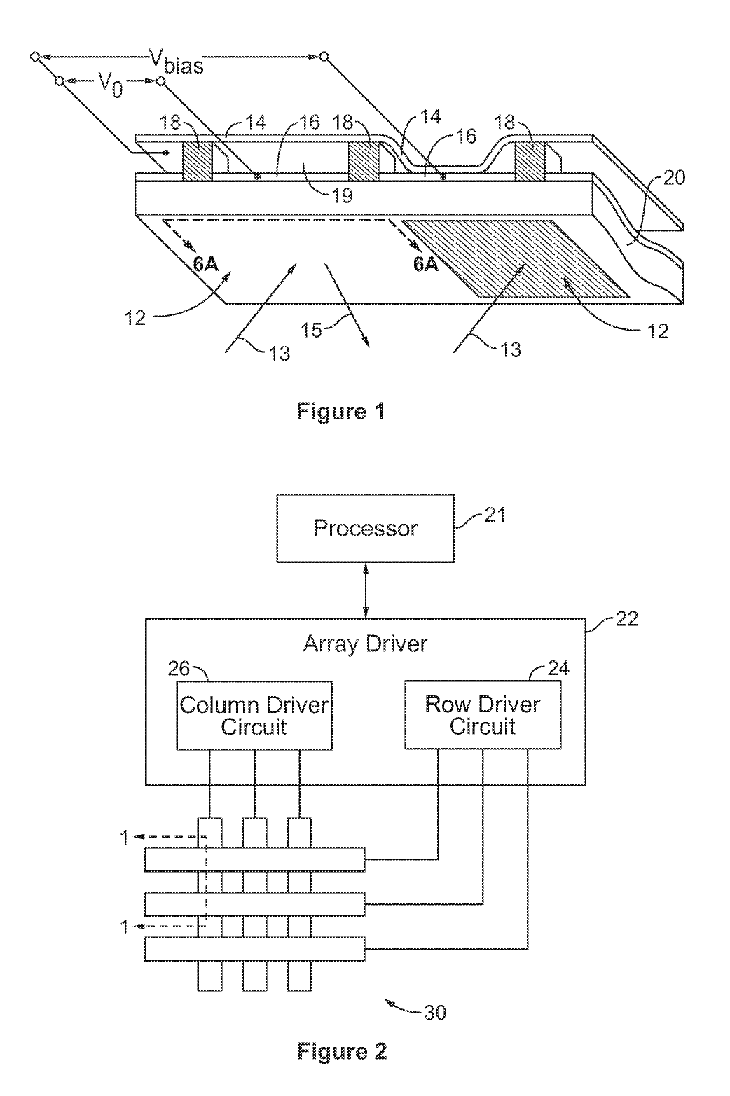

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, for example, to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, absorbing and/or destructively interfering light within the visible range. In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, such as chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and electrical conductor, while different, electrically more conductive layers or portions (for example, of the optical stack 16 or of other structures of the IMOD) can serve to bus signals between IMOD pixels. The optical stack 16 also can include one or more insulating or dielectric layers covering one or more conductive layers or an electrically conductive/optically absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, a voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

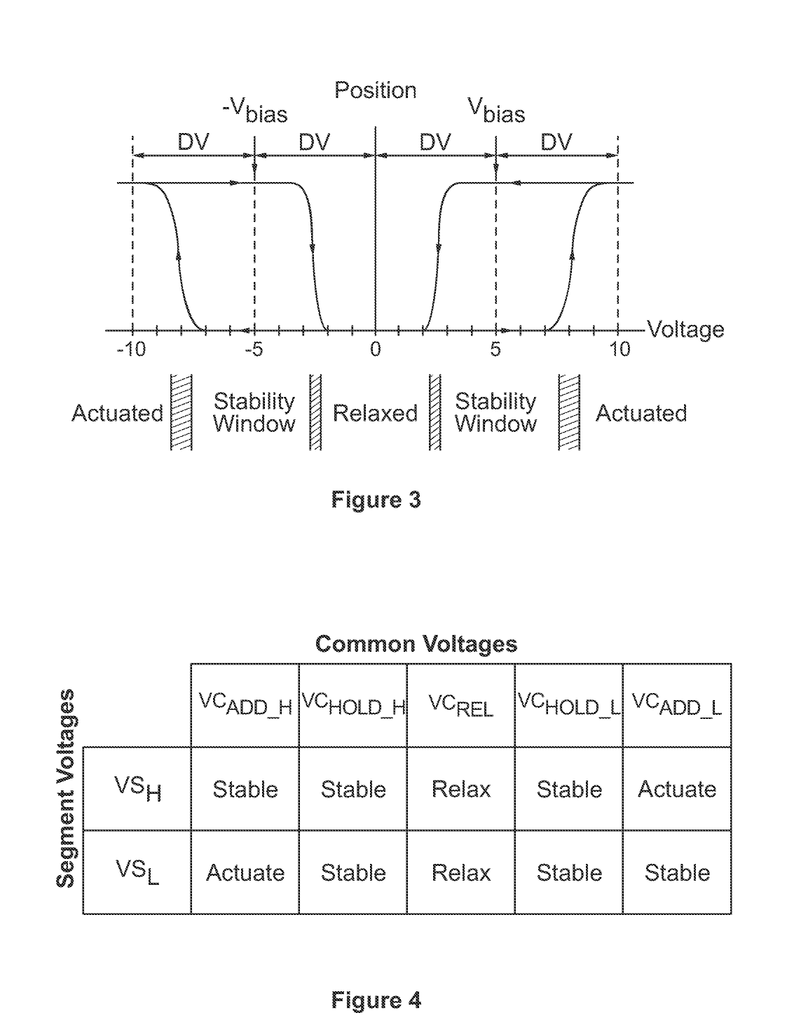

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example, a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

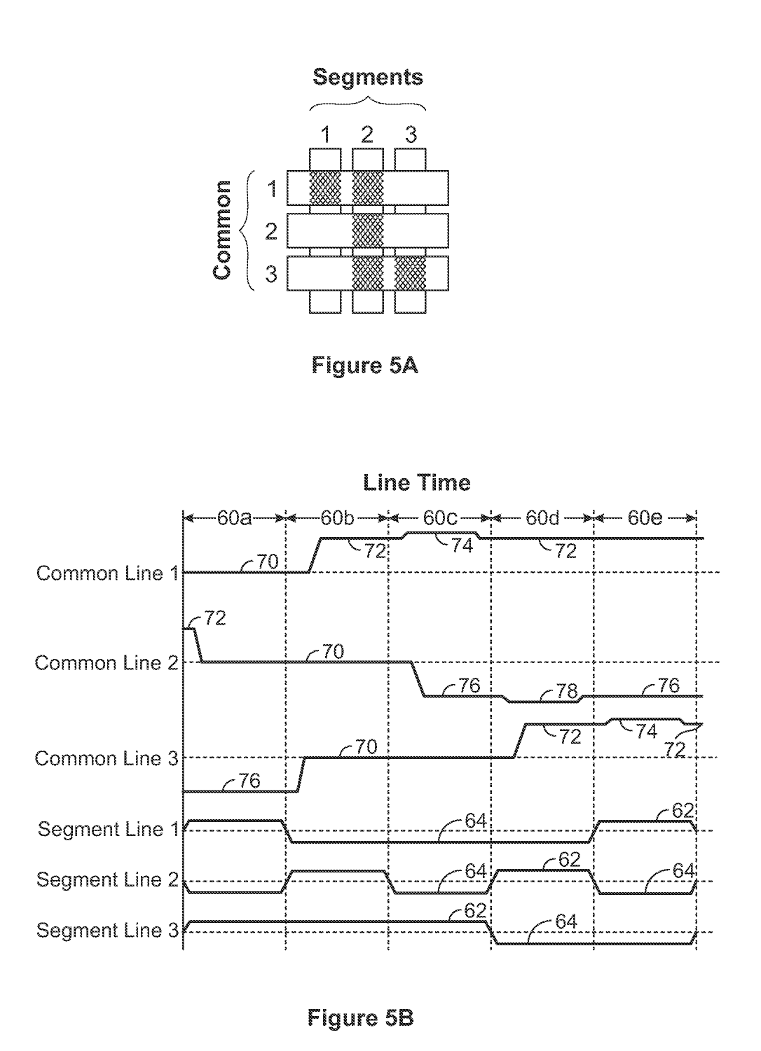

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3 to 7 volts, in this example, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about, in this example, 10 volts, and pixels that are to be relaxed are exposed to a voltage difference of near zero volts. After addressing, the pixels can be exposed to a steady state or bias voltage difference of approximately 5 volts in this example, such that they remain in the previous strobing state. In this example, after being addressed, each pixel sees a potential difference within the “stability window” of about 3-7 volts. This hysteresis property feature enables the pixel design, such as that illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

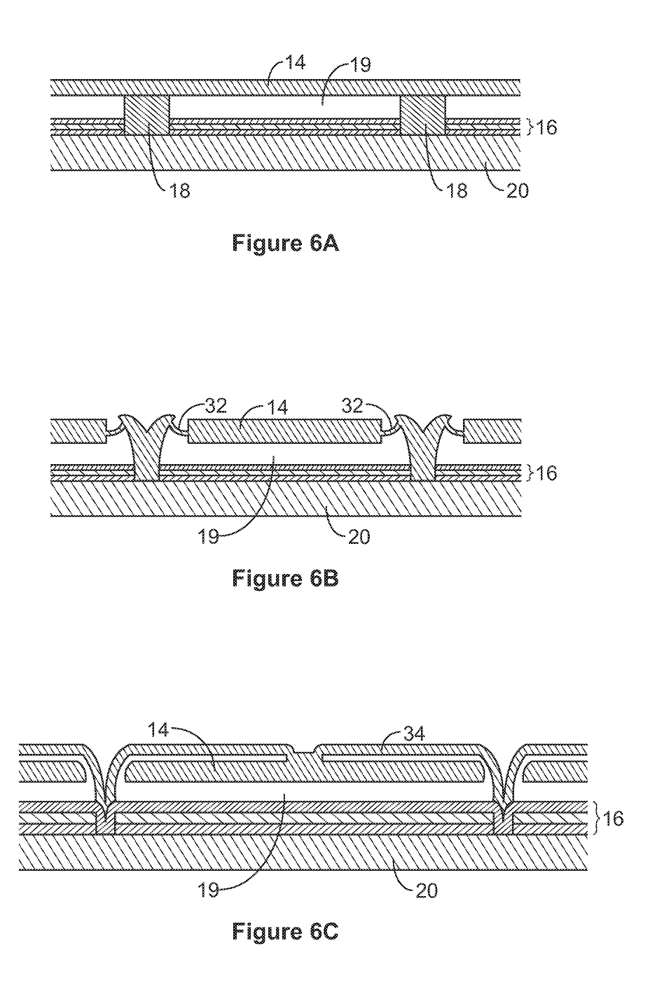

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be understood by one having ordinary skill in the art, the “segment” voltages can be applied to either the column electrodes or the row electrodes, and the “common” voltages can be applied to the other of the column electrodes or the row electrodes.

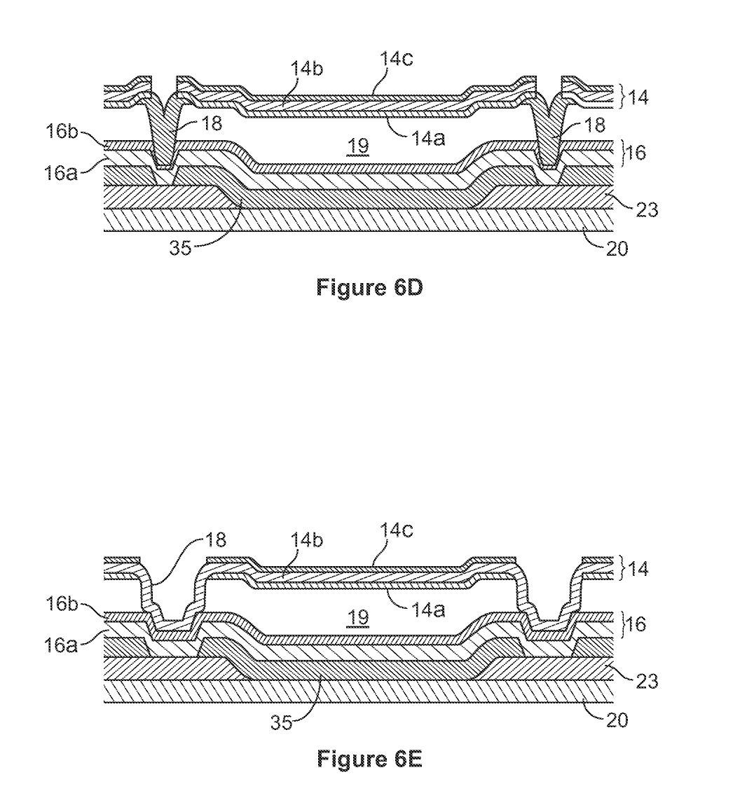

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator pixels (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to a 3×3 array, similar to the array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, for example, a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

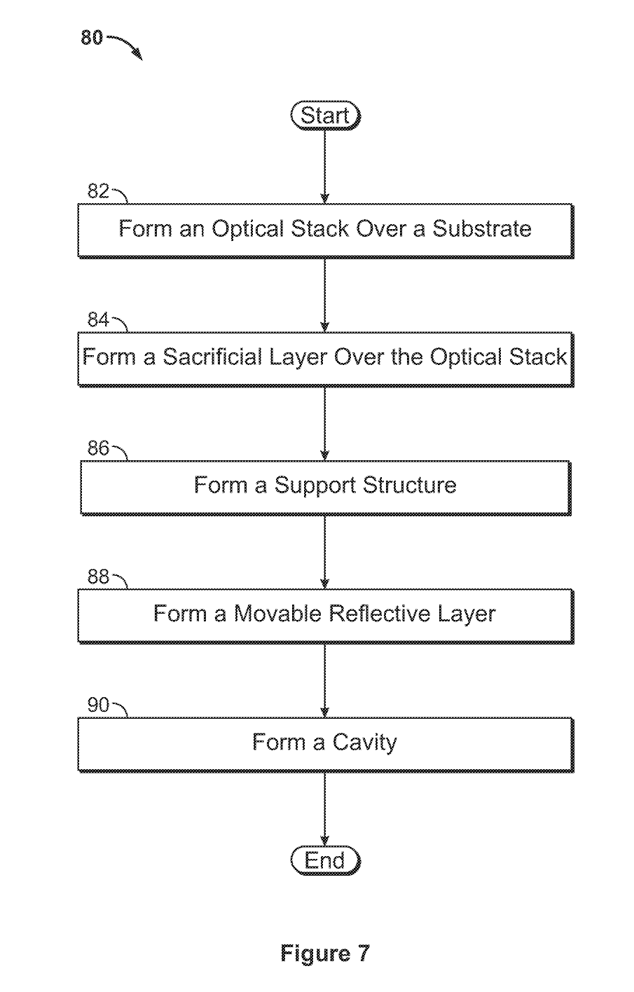

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (for example, between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer. In some implementations, the optical absorber 16a is an order of magnitude (ten times or more) thinner than the movable reflective layer 14. In some implementations, optical absorber 16a is thinner than reflective sub-layer 14a.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, for example, patterning.

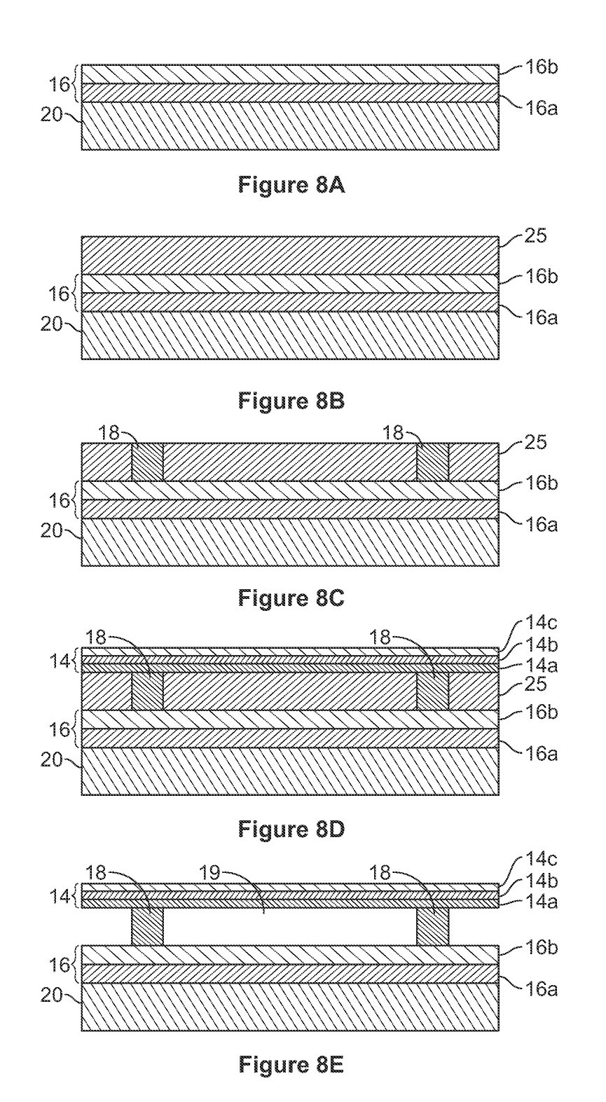

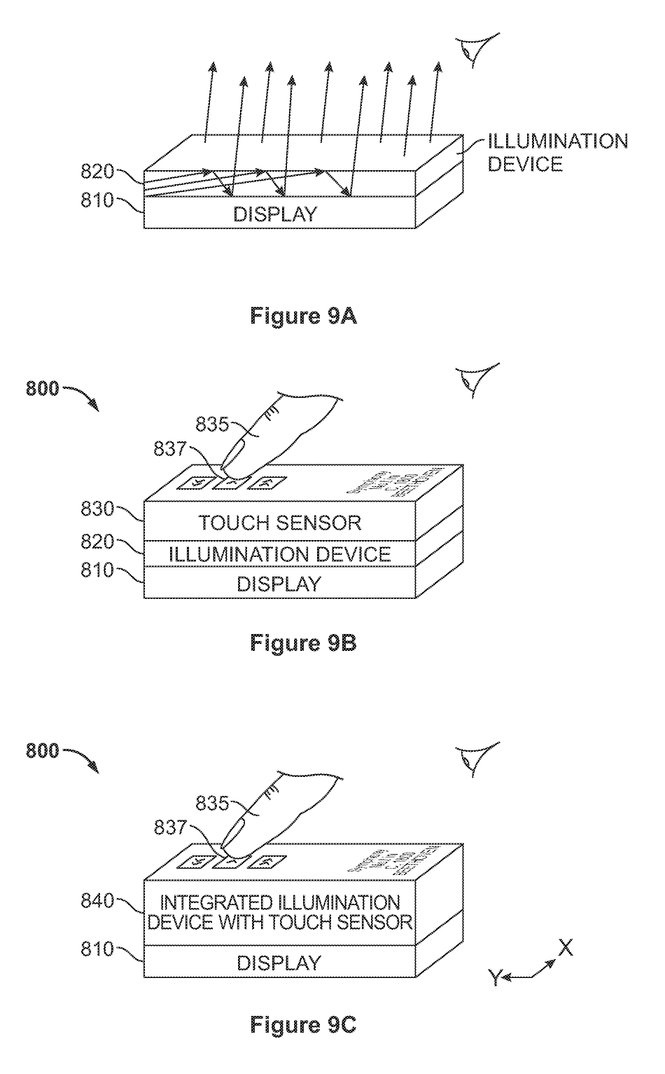

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture an electromechanical systems device such as interferometric modulators of the general type illustrated in FIGS. 1 and 6. The manufacture of an electromechanical systems device can also include other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, such as cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and electrically conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (for example, one or more reflective and/or conductive layers). In addition, the optical stack 16 can be patterned into individual and parallel strips that form the rows of the display. It is noted that FIGS. 8A-8E may not be drawn to scale. For example, in some implementations, one of the sub-layers of the optical stack, the optically absorptive layer, may be very thin, although sub-layers 16a, 16b are shown somewhat thick in FIGS. 8A-8E.

The process 80 continues at block 84 with the formation of a sacrificial layer 25 over the optical stack 16. The sacrificial layer 25 is later removed (see block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as post 18, illustrated in FIGS. 1, 6 and 8C. The formation of the post 18 may include patterning the sacrificial layer 25 to form a support structure aperture, then depositing a material (for example, a polymer or an inorganic material, for example, silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, for example, reflective layer (for example, aluminum, aluminum alloy, or other reflective layer) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, for example, cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, for example, by exposing the sacrificial layer 25 to a gaseous or vaporous etchant, such as vapors derived from solid XeF₂, for a period of time that is effective to remove the desired amount of material. The sacrificial material is typically selectively removed relative to the structures surrounding the cavity 19. Other etching methods, for example wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

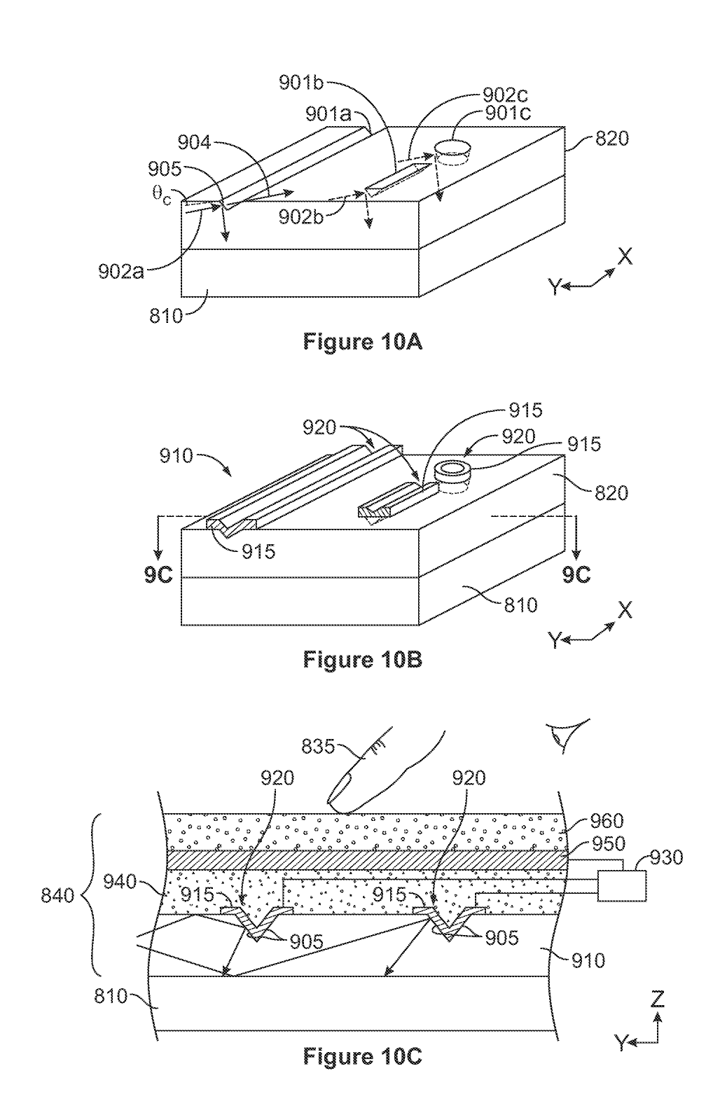

With reference now to FIG. 9A, an example of a display being illuminated by an illumination device is illustrated. Reflective displays, such as reflective displays including interferometric modulators (such as the interferometric modulators 12 of FIG. 1), may reflect ambient light towards a viewer thereby providing the viewer with a displayed image. However, in some circumstances, such as environments with low ambient light, reflective displays such as the display 810 shown in FIG. 9A, may require an additional illumination to provide sufficient light to the display 810 to display an image. For example, an illumination device 820 may be provided to illuminate the display 810. In some implementations, the illumination device 820 may be a front light with light-turning features to turn light guided within the light guide towards the display 810 allowing the turned light to reflect off of the display 810 towards the viewer. Light may be injected into light guide 820 by one or more light sources (such as light emitting diodes) coupled to the illumination device 820 (light sources not shown). Alternatively, in some other implementations, a light source may be coupled into an edge bar (not shown) which may then spread the light along the width of light guide 820 to be guided within light guide 820 and then ejected towards the display 810 to illuminate the display 810.

With reference now to FIG. 9B, an example of an illustration of a display with an illumination device and a touch sensor is shown. In some implementations, it may be desirable to include touch sensor capability for the display 810, to allow a user to provide user inputs by “touching” a display image. As shown in the implementation of FIG. 9B, the display 810 is illuminated with the illumination device 820 and stacked over the illumination device 820 is touch sensor 830. In some implementations, the touch sensor 830 is capable of determining the location of a touch by sensing a change to the capacitance of a conductor formed in the touch sensor 830. The change to the capacitance of the conductor can be induced by the proximity of a conductive body, for example, a human finger 835. The use of touch sensor 830 with illumination device 820 allows for the useful interaction of the user's finger with the display system 800. For example, by touching the screen in different locations, the user may use his or her finger 835 to select a certain icon 837 displayed by the display 810 of the display system 800. In some implementations, the illumination device 820 is not integrated with touch sensor 830 and the illumination device 820 and the touch sensor 830 may be mechanically stacked one on top of the other. As shown in FIG. 9B, the touch sensor 830 is stacked over the illumination device 820, however, in other implementations, the illumination device 820 may be stacked over the touch sensor 830. As shown, the touch sensor 830 is closer to the user viewing the display 810. In yet other implementations, the touch sensor 830 may be behind the display 810. In some other implementations, rather than being a capacitive touch sensor, the touch sensor 830 may be various other types of touch sensors known in the art, including, without limitation, a resistive touch sensor.

With reference to FIG. 9C, an example of an illustration of a display with an integrated illumination device with touch sensor is shown. FIG. 9C shows an illumination device integrated with a touch sensor, thereby forming the integrated illumination device with touch sensor 840, which is formed over a display 810. The integrated illumination device with touch sensor 840 is closer to the viewer than the display 810, that is, on an image-displaying side of the display 810. The illumination device integrated with touch sensor 840 can simultaneously illuminate the reflective display 810 to provide for illumination while also allowing for touch sensor capability. In various implementations, one or more components of the illumination device integrated with touch sensor 840 simultaneously have illumination as well as touch-sensing function. For example, conductors formed in the illumination device integrated with touch sensor 840 may provide both illumination capabilities as well as touch-sensing capabilities as will be described in greater detail below.

One way of integrating the illumination device 820 and the touch sensor 830 of FIG. 9B to form an implementation as illustrated in FIG. 9C is to use metalized light-turning features in the illumination device 820 while simultaneously using the metalized light-turning features of the illumination device as conductors in electrical communication with touch-sensing electronics. The touch-sensing electronics may be capable of sensing a change to a capacitance of the conductor induced by the proximity of a human finger 835. Such a system is described further below. In this configuration, both the metalized light-turning features and the conductors function as optical contrast features against the background of the light guide. In addition, various other features in the light guide can function as an optical contrast feature. For example, other electronic components, printed dots, or even gaps in the illumination device can each function as optical contrast features.

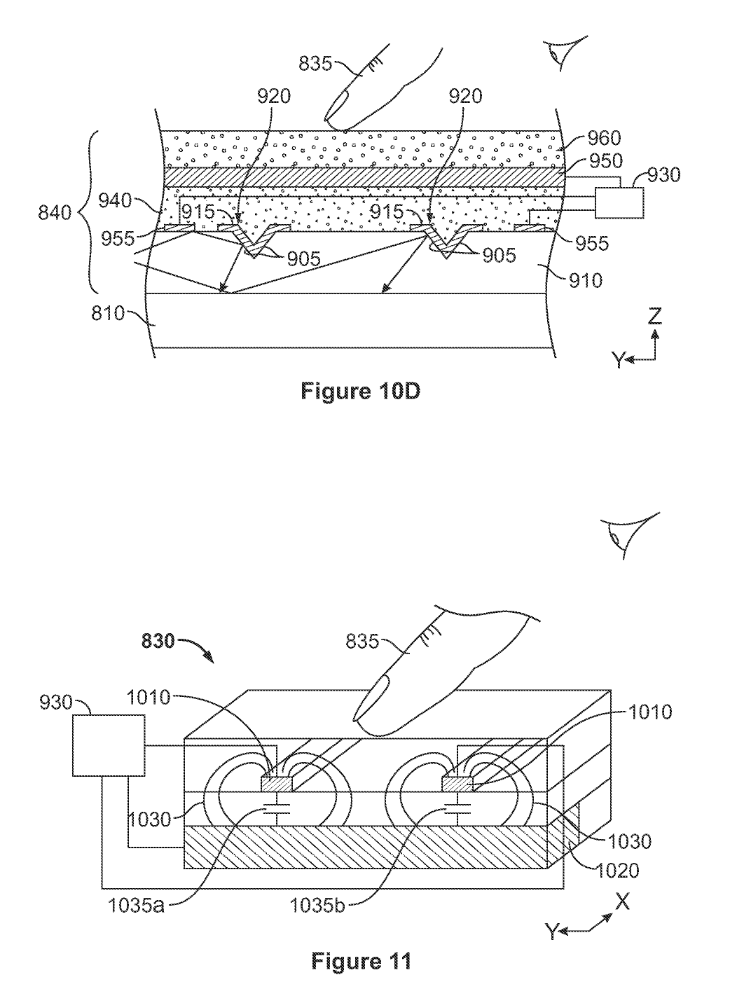

With reference to FIG. 10A, an example of an illustration of a light guide is shown. FIG. 10A depicts an implementation of an illumination device 820 including light-turning features 901a, 901b, and 901c. Such features can “turn” light propagating in light guide 820 out of the light guide and toward a display 810. As shown in FIG. 10A, the light-turning features 901a, 901b, and 901c include surfaces 905 that can reflect or turn light. Also as shown in FIG. 10A, the light-turning features 901a, 901b, and 901c can include one or more different shapes. For example, the light-turning features 901a, 901b, and 901c may extend longitudinally in one direction, for example, the x direction, as illustrated in feature 901a. In some other implementations, the light-turning features 901a, 901b, and 901c may include a feature which is discrete and spaced-apart from other features, such as light-turning features 901b and 901c, which are smaller in area than the elongated feature 901a and may be rotationally symmetrical (as viewed from above) or form an “island” on the light guide 820. Also light-turning features 901a, 901b, and 901c may include pyramidal, conical or trapezoidal features or other features or cross-sectional profiles capable of redirecting a light ray 902a, 902b, and 902c, toward a display 810.

In some implementations, it may be useful to form metal conductors on light-turning features 901a, 901b, and 901c. The light-turning features may include various types of structures, for example, diffractive and reflective structures, that redirect light. In some implementations, the light-turning features 901a, 901b, and 901c are reflective, with the reflections occurring on surfaces of the light-turning features. Reflection off the surfaces of the light-turning features 901a, 901b, and 901c may be facilitated by forming a metal conductor on the surface 905, thereby “metalizing” the surface 905 and making that surface reflective.

With reference to FIG. 10B, an example of an illustration of a light guide with metalized light-turning features is shown. In FIG. 10B, illumination device 910 includes a light guide 820 including a conductor 915 formed on a surface of a recess to form metalized light-turning features 920. Although all of the light-turning features 920 in FIG. 10B are shown fully metalized, it is understood that a light-turning feature 920 need not be completely metalized. For example, a light-turning feature that extends as a long groove (such as, light-turning feature 901a in FIG. 10A) may only be metalized at certain points along the groove (i.e., the x direction), and not along the entirety of the groove. In addition, some light-turning features can be partly and/or completely metalized while others are not metalized. In some implementations, the conductor 915 is a reflective metal conductor.

With reference to FIG. 10C, an example of a cross-sectional view of an implementation of a light guide with metalized light-turning features with integrated touch sensor is shown. FIG. 10C depicts an implementation of an illumination device with conductive features integrated into the light-turning features 920. While shown as having a v-like cross-section, it is understood that metalized light-turning features 920 may have various shapes, such as a tapered cylinder or other shape having surfaces angled to direct light out of the light guide (for example, downwards), as indicated, for example, with reference to the light-turning features 901a, 901b, and 901c of FIG. 10A. The illumination device 840 includes a light guide 910 including light-turning features 920 having light-reflecting conductors 915 formed on light-turning features 920. The illumination device also can include touch-sensing electronics 930 which are electrically connected to light-reflecting conductors 915 and electrodes 950. In some implementations, the light-reflecting conductors 915 may be part of a light-turning feature 920 over the entire length of the light-turning feature 920, or may only extend over part of the length of the light-turning features 920, or may extend farther than the length of light-turning features 920. The touch-sensing electronics 930 may be connected to some of the light-reflecting conductors 915, while other light-reflecting conductors 915 are not electrically connected to the touch-sensing electronics 930. In some other implementations, as illustrated, neighboring light-reflecting conductors 915 may be electrically connected to touch-sensing electronics 930. The touch-sensing electrode system may but does not necessarily include a plurality of conductors 915 that are part of metalized light-turning features and a plurality of conductors that are not part of any light-turning feature (which may collectively be referred to as “electrodes”) in electrical communication with touch-sensing electronics 930. Touch-sensing electronics 930 may be capable of detecting a change to a capacitance of the conductor 915 induced by the proximity of a conductive body, for example, a human finger 835, and hence the electrode system as a whole is capable of detecting a change to a capacitance of the conductor 915 induced by the proximity of a human finger 835. Using conductors 915 formed on a light-turning feature also as part of a capacitive touch sensor allows for integrating touch-sensor capability with a light guide.

In the implementation illustrated in FIG. 10C, the illumination device integrated with touch sensor capability 840 includes layers over the light guide 910. For example, the layer 940 may be a dielectric layer to electrically isolate conductors 915 from electrode 950 (with electrode 950 extending along the y direction). While only one electrode 950 is shown in the cross-sectional view of FIG. 10C, some implementations may include many electrodes like electrode 950 in parallel extending along the y direction orthogonal to conductors 915. In some implementations, the layer 940 may include silicone or other non-corrosive dielectric. Non-corrosive materials are preferred, so as not to degrade or corrode conductors 915. In some implementations, the layer 940 may be a pressure sensitive adhesive (PSA) layer that is pressed onto or over the light guide 910. Layer 940 may have an index of refraction higher than that of air but lower than that of the light guide 910 by about 0.05 or 0.1 or more, thereby functioning as a cladding layer. Additionally, illumination device integrated with touch sensor capability 840 may include other layers, such as a layer 960 to passivate or protect underlying layers from chemical and/or mechanical damage.

With reference to FIG. 10D, an example of an illustration of a cross-sectional view of a light guide with metalized light-turning features and touch-sensing electrodes is shown. The implementation of FIG. 10D is similar to the implementation of FIG. 10C, except that the touch-sensing electronics 930 is not electrically connected to the light-turning features 920. In such an implementation, touch sensing may be accomplished using a grid of electrodes like electrodes 950 (extending in the y direction) and 955 (extending in the x direction, out of the page). It is understood that, alternatively, the touch-sensing electrode may not be a grid, and hence may only include electrodes 955 (in which case electrodes 955 may include discrete electrodes) without electrodes 950. Such an implementation may be manufactured using relatively few steps, where electrodes 955 and the metallic coating of light-turning features 920 are deposited and etched using the same process. In some other implementations, the touch-sensing electronics 930 can be electrically connected to both the metalized light-turning features 920 and the electrodes 955, in addition to being electrically connected to the electrodes 950, or without being electrically connected to the electrodes 950. In some implementations, only some of the light-turning features 920 are connected to the touch-sensing electronics 930. While electrode 950 is shown as perpendicular to and arranged on another layer over electrodes 915 and 955 it is understood that they can instead be perpendicular and arranged on the same layer. In such a configuration, at least one of the electrodes includes breaks to prevent shorts at the intersection of electrodes 950 with electrodes 915 or 955. Jumpers can be provided to bridge these breaks in the electrodes. The jumpers and extend above and/or below an intersecting electrode, without contacting the intersecting electrode.

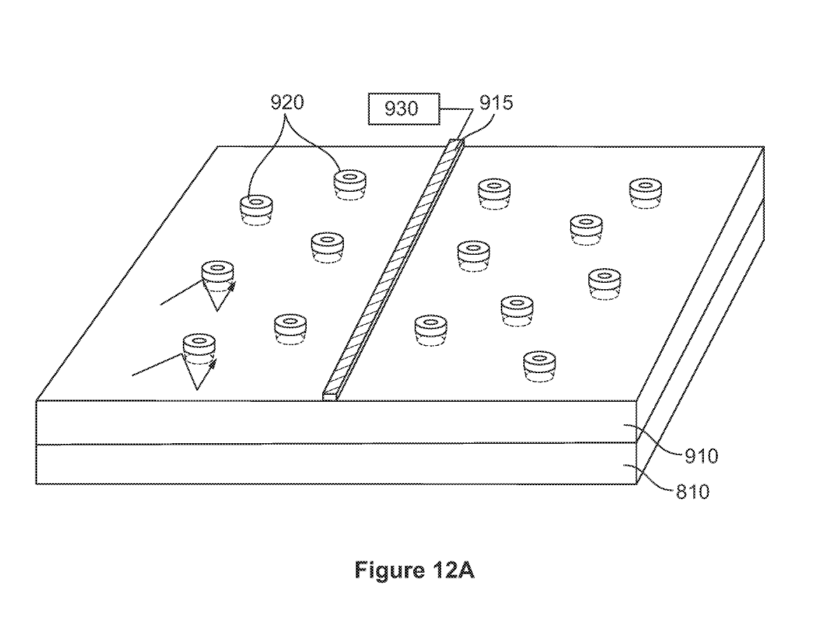

With reference to FIG. 11, an example of an illustration of an implementation of a touch sensor is shown. The touch sensor may be a capacitive touch sensor. In general, and as depicted in the implementation of FIG. 11, the capacitive touch sensor includes conductors which serve as electrodes 1010, 1020. As depicted in the implementation of FIG. 11, electrodes 1010 extend in the x direction, while electrodes 1020 extend in the y direction. If a current is passed in one of electrodes 1010 or electrodes 1020, an electric field, illustrated in FIG. 11 by field lines 1030, may form between electrodes 1010 and electrodes 1020. The electric fields formed between electrodes 1010 and 1020 are related to a mutual capacitance 1035a and 1035b. When a human finger 835, or any other conductive body or object, is brought in the proximity of electrodes 1010 or 1020, charges present in the tissues and blood of the finger may change or affect the electric field formed between electrodes 1010 and 1020. This disturbance of the electric field may affect the mutual capacitance and can be measured in a change in the mutual capacitance 1035a, 1035b, which may be sensed by touch-sensing electronics 930 to determine the location of a “touch.” The conductors 915 of FIG. 10C may simultaneously serve the optical functions described elsewhere herein and may serve as electrodes 1010 or 1020 depicted in FIG. 11.

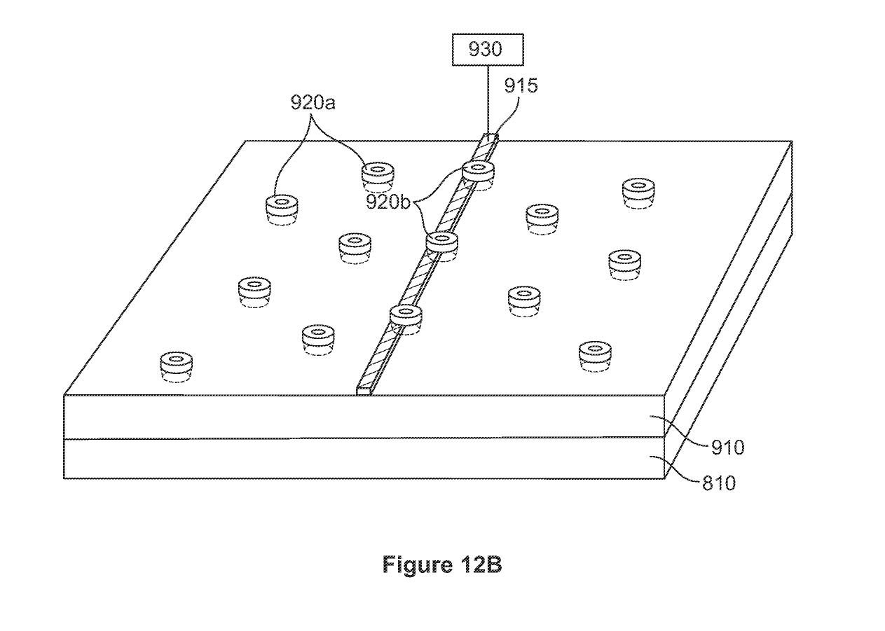

In the implementations described above, it is understood that an integrated touch sensor and light guide may include metalized light-turning features as well as metalized electrodes as part of a touch-sensing system. In some implementations, metalized light-turning features may be placed relative to a touch-sensing electrode so as to obscure the touch-sensing electrode. With reference now to FIG. 12A, an example of an illustration of a light guide having light-turning features with an integrated touch sensor is shown. In some implementations, the light-turning features can be metalized. In the illustrated implementation, light-turning features 920 constitute discrete optical contrast features and are capable of redirecting light propagating in the light guide 910 towards a display 810. A conductor 915 constitutes an elongated optical contrast feature and runs along the upper surface of the light guide 910. As illustrated, the conductor 915 can be elongated and form an electrode or wire, which can be part of a touch-sensing system, for example by electrically connecting to other electrodes, conductors, and touch-sensing electronics 930. Although shown as being formed over the top surface of the light guide 910, in other implementations the conductor 915 may be embedded within the light guide 910. For example, a groove may be etched into the top surface of the light guide 910. Conductive material may then be deposited into the groove, thereby forming a conductor 915 that is embedded within the light guide 910. Conductor 915 can be made from a reflective metal. In some implementations, the conductor 915 may be made from the same material used to metalize light-turning features 920. In some other implementations, the conductor 915 can be made from a transparent conductor such as indium tin oxide (ITO) or zinc oxide (ZnO). As shown in FIG. 12A, the light-turning features 920 are distributed over the upper surface of the light guide 910. The distribution of light-turning features 920 may be adjusted in order to achieve a uniform illumination across the entire surface of the light guide 910. This may involve, for instance, an increasing density of light-turning features with increased distance from a light source. The spacing between adjacent light-turning features 920 may range from about 10 microns to about 150 microns in some implementations, although other ranges are possible depending upon the application. Although FIG. 12A shows light-turning features 920 as metalized, some or all of those light-turning features may be non-metalized in some implementations.

As noted above, the conductor 915 may serve as an electrode connecting to a touch-sensing electronics 930. Accordingly, the position of the conductor 915 is selected based upon the needs of a touchframe wire sensor system. For example, given the dimensions of a human finger, the pitch of adjacent electrodes that are part of a touch-sensing electronics may be approximately one centimeter (cm). It will be understood that “pitch” may refer to the distance between identical points of two similar immediately neighboring electrodes. In applications in which touch-sensing higher precision is required, spacing between adjacent electrodes may be decreased, for example to 0.5 cm or less. Similarly, spacing between adjacent electrodes may be greater in other applications where high precision is of less importance.

FIG. 12B is another example of an illustration of a light guide with light-turning features with an integrated touch sensor. Light-turning features 920a are distributed along the upper surface of the light guide 910. In contrast to FIG. 12A, however, light-turning features 920b overlap and may be integrated with the conductor 915, for example being formed of the same material extending continuous between the conductor 915 and the light-turning features 920b. Light-turning features 920b can be metalized, and can be connected to the conductor 915. The conductor 915, in turn, can be connected to other electrodes, conductors, and touch-sensing electronics 930. As noted with respect to FIG. 12A, the conductor 915 may be made from the same metal material that can be used to metalize the light-turning features 920a and/or 920b. For example, the metal material may be deposited as a blanket layer and then etched to define the conductor 915 and the light-turning features 920a and/or 920b. As shown in FIG. 12B, not all light-turning features are integrated or in electrical communication with the touch-sensing electronics 930. Depending upon the density of light-turning features, in certain implementations, one in ten, or less, light-turning features may be in electrical communication with the touch-sensing electronics 930. Accordingly, in certain implementations, the number of light-turning features 920b in electrical communication with the touch-sensing electronics 930 may be far fewer than the number of light-turning features 920a.

The particular materials used to form both a metallic layer over light-turning features 920a and 920b, as well as the conductor 915 may vary. In some implementations, a layer of aluminum may define the lower surface of the light-turning features 920a and 920b. In some implementations, multiple layers of material may be disposed in a recess forming the light-turning features 920a and 920b. For example, in some implementations, the conductor 915 may be part of an interferometric stack that forms a “black mask” for reducing reflections to a viewer. In certain implementations, the conductor 915 including light-turning features formed thereon can be part of the black mask. The black mask can include: a reflective layer (such as the conductor 915) that re-directs or reflects light propagating within the light guide 910, an overlying optically transmissive spacer layer, and an optical absorber overlying the spacer layer. The spacer layer is disposed between the reflective layer and the optical absorber and defines a gap by its thickness. In operation, light can be reflected off of each of the reflective layer and absorbed at the absorber, with the thickness of the spacer layer selected such that the reflected light is absorbed by the absorber so that the conductor 915 appears black or dark as seem from above by the viewer. In one example, the conductor 915 may be an aluminum layer covered with a layer of silicon dioxide as the spacer layer, followed by a layer of molybdenum chromium as the optical absorber. In addition, a layer of silicon dioxide may be provided over the partially reflective layer as passivation layer to protect against corrosion of the underlying layers. One having skill in the art will recognize that myriad other different materials and combinations of materials may be used to form conductor 915 and light-turning features 920a and 920b.

In many illumination devices integrated with touch sensors, the touch sensor electrodes are visible to a viewer under certain conditions. In some implementations, the electrodes can have a width of between about 3 microns and about 20 microns. Nevertheless, even at these dimensions, the electrodes may be visible to a viewer. This is due, in part, to certain imperfections in the optics of the human eye that can result in objects appearing larger than they are, due to various optical limitations of the human eye. For example, when visual stimuli are passed through the cornea and lens, the stimuli undergo a certain degree of degradation. The limitations in resolution may be represented as the point spread function, or line spread function of the human eye. Qualitatively, these functions represent the degree to which a point or line “blurs” as perceived by a human viewer. More precisely, the point spread function of the human eye represents the intensity distribution of light available at the level of the retina. The point spread function may be calculated using the following equation:

Q(ρ)=0.952^{(-2.59|ρ|}^{^{1.36}}⁾+0.048^{(-2.43|ρ|}^{^{1.74}}⁾

Where ρ is the radial distance from the geometrical point image, measured in minutes of arc visual angle. As a line may be considered to be made up of a string of points, the line spread function can be considered the superposition of the point spread functions of a row of finely spaced points. The line spread function can therefore be derived from the point spread function. For a radially symmetrical point spread function s(ρ), the corresponding line spread function A(α) can be found using the following equation:

$$A ( α ) = 2 {\int }_{α}^{∞} s ( ρ ) {( {ρ}^{2} - {α}^{2} )}^{- \frac{1}{2}} ρ d ρ$$

Where α is an angular measure of the distance from the geometrical image of the line in a direction normal to the line, and ρ is a measure of the radial angular distance from the center of the geometrical point image. Empirical analysis provides a line spread function calculated by the following equation:

A(α)=0.47^{(-3.3α}^{²}⁾+0.53^{(-0.93|α|)}

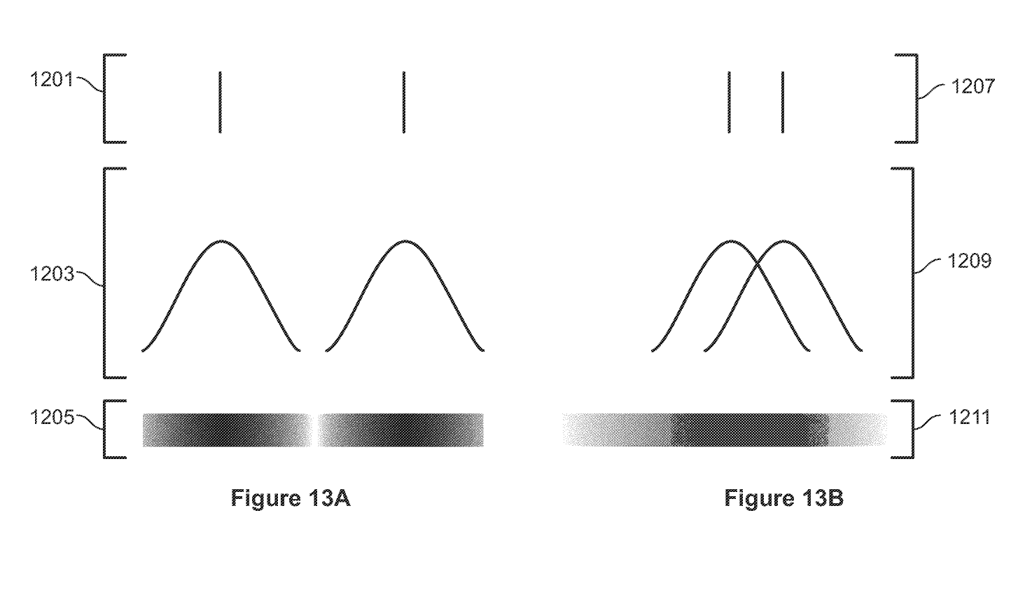

FIGS. 13A and 13B are examples of illustrations of the degradation of visual stimuli due to the optics of the human eye. With respect to FIG. 13A, block 1201 shows a pair of lines as present in visual space. Block 1203 shows the corresponding line spread functions for each of these lines. The horizontal axis is retinal distance (typically represented as angular distance), while the vertical axis is relative intensity. As can be seen in FIG. 13A, the pair of lines shown in block 1201 result in a distribution of light received at the retina in which the highest relative intensity corresponds to the actual location of the line, with dropping intensity with angular distance from that location. Block 1205 represents the visual perception of the two lines shown in 1201. Due to the point spread functions illustrated in block 1203, the lines appear “blurred” and spread out. In some implementations, the “blur” occurs primarily over an angular distance of approximately 2.2 minutes of arc from the geometric center in each direction. With respect to a line, rather than a point, the “blur” occurs primarily over an angular distance of approximately 5 arc minutes on either side of the line.

In FIG. 13A, the two lines are spaced apart enough that, despite the blurring effect of the line spread functions, the two lines remain visually distinguishable. In FIG. 13B, a similar illustration is shown, except that the two lines are shown as closer together in visual space in block 1207. Block 1209 shows the corresponding line spread functions for each of the lines. Here, unlike in FIG. 13A, the line spread functions overlap significantly. Although shown as separate line spread functions for clarity, the overall light received at the retina is a superposition of these two line spread functions. The result, shown in block 1211, is the visual perception of a single, blurred line that is both wider, and darker than each of the lines as perceived in block 1205 of FIG. 13A. In effect, the lines in block 1207 of FIG. 13B are presented close enough together that the distance between them exceeds the visual acuity of the human eye, and the lines become indistinguishable. For the human eye, a typical line spread function at a viewing distance of approximately 16 inches is characterized by a full width at half-max of approximately 150 microns.

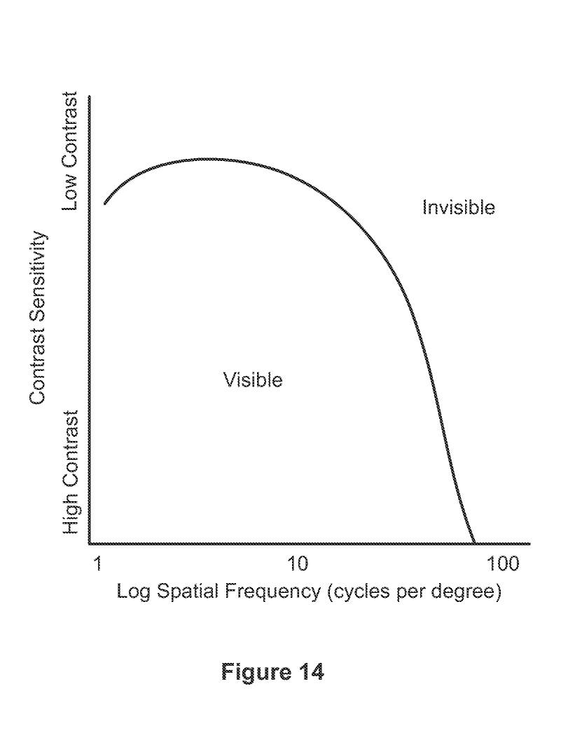

Visual perception depends not only on resolution, but also on relative contrast, or the contrast ratio. The human eye is more sensitive to contrast than to absolute luminance. Sensitivity to contrast, however, varies with the spatial frequency. The spatial frequency is the number of “cycles” of contrast per degree subtended at the eye. For example, one cycle could include a single black line and a white space next to it, with this pattern repeating. The contrast sensitivity function describes how the human eye's contrast sensitivity varies with spatial frequency. FIG. 14 shows a graph of the contrast sensitivity function for the human eye. The vertical axis is contrast sensitivity, with low contrast at the top and highest contrast at the bottom. The horizontal axis is the log of spatial frequency, as measured in cycles per degree. As the spatial frequency increases, i.e., the visual features become smaller and smaller, or closer and closer together, the level of contrast necessary in order for these features to be visible increases. Past a certain threshold, certain features are invisible to the human eye, even at the highest contrast. This corresponds to the limit of angular resolution, discussed above. But even below the limit to angular resolution of the human eye, decreased contrast can render features invisible to the human eye.

It has been found that these limitations in the optics of the human eye may be used to decrease visibility of certain features in optical systems. For example, an elongate optical contrast feature disposed within an array of discrete optical contrast features may be hidden, or at least have reduced visibility, depending on the arrangement of the features. For example, an elongate optical contrast feature, such as conductor 915 (FIGS. 12A and 12B), disposed on a substrate, will have a particular line spread function, which can have an effective width of about 400 microns, or less in some instances. Similarly, each discrete optical contrast feature, for example a light-turning feature, such as a light-turning feature 920 (FIGS. 9A-12B) or other light-blocking element, will have a particular point spread function. If any discrete optical contrast feature is close enough to the elongate optical contrast feature to fall within its line spread function, then the line spread function of the discrete optical contrast feature will overlap with that of the elongate optical contrast feature. The superposition of these two line spread functions can result in an increased effective perceived width of the elongate optical contrast feature.

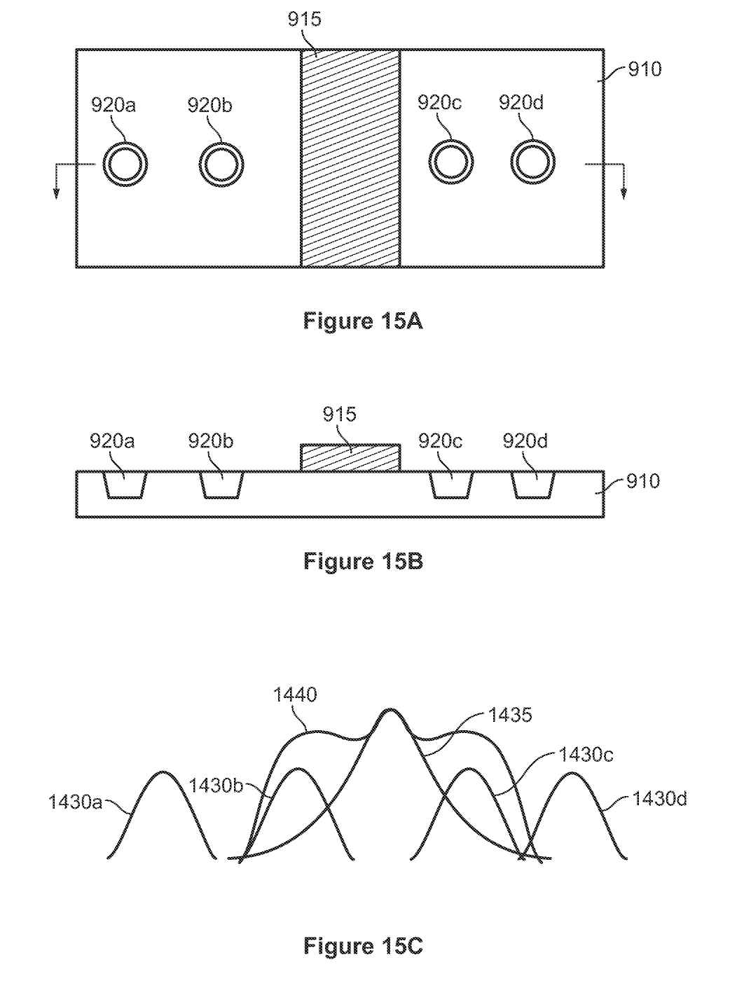

For example, FIGS. 15A and 15B show examples of illustrations of a portion of a light guide with light-turning features and a conductor. In some implementations, the light-turning features 920a-d may be metalized light-turning features. Additionally, in certain implementations the conductor 915 may be a wire, for example a wire for a touch sensor system, as discussed herein. FIG. 15A is a top view of the light guide, and FIG. 15B shows a cross-sectional view. The light guide 910 includes conductor 915, which constitutes an optical contrast feature, and four illustrated light-turning features 920a-d, which each constitutes a discrete optical contrast feature. The conductor 915 may form part of an electrode array for a touch-sensing system. Although the light-turning features 920a-d are shown as arranged in a single line, other arrangements are possible. As noted previously, the arrangement of light-turning features 920a-d can be determined based upon the desired illumination. For example, uniform illumination may require varying density of light-turning features with distance from a light source (not shown).

FIG. 15C shows an example of an illustration of the line spread functions associated with the light guide 910 shown in FIGS. 15A and 15B. Line 1430a corresponds to the point spread function associated with light-turning feature 920a. Similarly the lines 1430b, 1430c, and 1430d show the point spread functions corresponding to each of the light-turning features 920b, 920c, and 920d, respectively. Line 1435 shows the line spread function of the conductor 915. As the conductor 915 is larger than the light-turning features 920a, 920b, 920c, and 920d, its line spread function is both taller, indicating greater relative intensity, and wider due to the increased width of conductor 915. Line 1440 represents the superposition of the overlapping point and line spread functions 1430b, 1440, and 1430c. The sum of these separate point and line spread functions creates an intensity distribution that is significantly wider than that of the conductor 915 or any of the light-turning features 920a-d alone. The result of the overlapping point spread functions of the light-turning features 920b and 920c with the line spread function of the conductor 915 is an increased perceived width of the conductor 915.

Even though the individual light-turning features 920a-d may each be individually undetectable to a human observer at a given viewing distance, the arrangement of these light-turning features 920a-d within the line spread function of the conductor 915 may result in effectively increasing the perceived width of the conductor 915. In implementations where the conductor 915, in isolation, is already visible to the naked human, providing light-turning features 920a-d within the line spread function of the conductor 915 may further increase the visibility of the conductor 915. In either case, the apparent width and/or intensity of each of the light-turning features 920a-d can be increased by overlap with the point spread function of neighboring light-turning features.

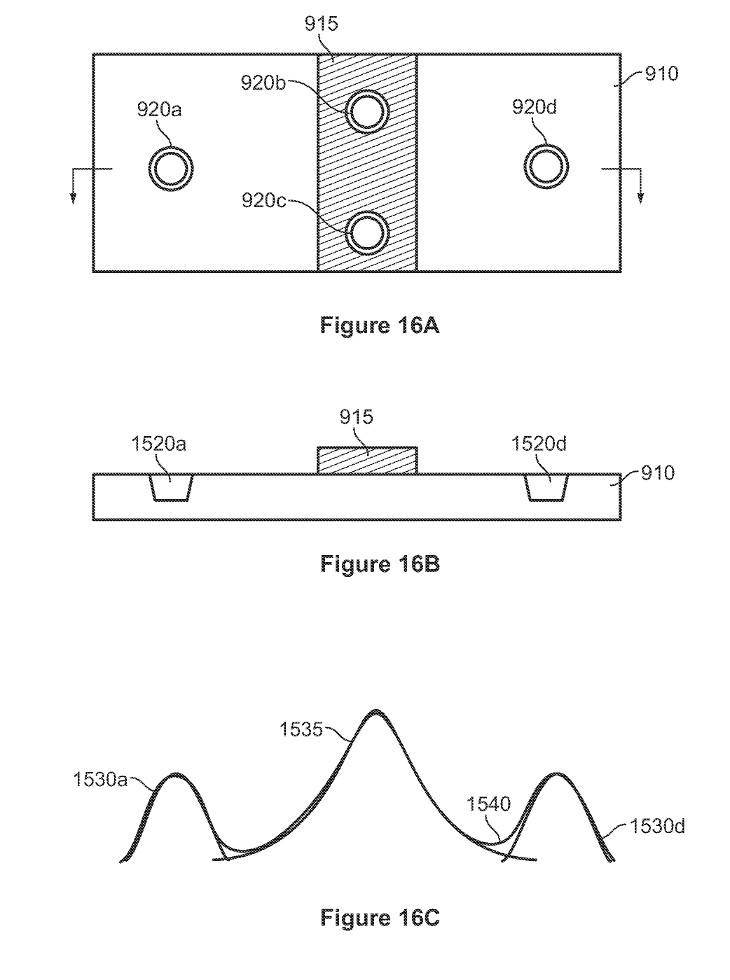

Even where an elongate optical contrast feature, such as the conductor 915, is visible to the naked human eye in isolation, it has been found that particular arrangements of discrete optical contrast features around an elongate optical contrast feature can be used to “hide” the elongate feature. For example, removing at least some of the light-turning features from the area immediately surrounding the conductor can reduce any increase in perceived width and also roughly equalize the optical density of optical contrast features 920a-d across a surface containing the light-turning features 920a-d and conductor 915, thereby effectively hiding the conductor 915 within the array of light-turning features 920a-d. For example, FIGS. 16A and 16B show examples of illustrations of a portion of a light guide with light-turning features overlapping with a conductor. Light guide 910 includes two light-turning features 920b and 920c that have been positioned overlapping with the conductor 915. Light-turning features 920a and 920d are arranged at a distance from the conductor 915. In comparison to FIGS. 15A-B, the light-turning features closest to the conductor 915 have been relocated to overlap with the conductor 915. By overlapping with the conductor 915, light-turning features 920b and 920c provide little to no additional optical obscuration as compared to the conductor 915 on its own. In certain implementations, the light-turning features 920b and 920c may have dimensions that extend beyond the sides of the conductor 915. For example, the conductor 915 may be between about three to five microns across, and light-turning features 920b and 920c may be substantially circular with a diameter of between about 5 to 10 microns. In such configurations, there will be some increased optical density to the conductor 915 due to the overlapping light-turning features 920b and 920c. However, even in a configuration in which the light-turning features 920b and 920c are wider than the conductor 915 itself, the total optical density remains less than would be the case if the conductor 915 and light-turning features 920b and 920c were not overlapping.

FIG. 16C shows an example of an illustration of the spread functions associated with the light guide shown in FIGS. 16A and 16B. As a result of the overlapping arrangement of light-turning features 920b and 920c over the conductor 915, the spread functions illustrated in FIG. 16C differ significantly from those illustrated in FIG. 15C. Compared with the line spread functions in FIG. 15C, there is less overlap between the line spread function of the conductor, shown as line 1535, and that of the two adjacent optical contrast features 920a and 920d, whose point spread functions are shown as lines 1530a and 1530d, respectively. As noted above, the light-turning features 920b and 920c are positioned over the line 1550, and accordingly there is little or no separate point spread function associated with those light-turning features. As a result, the superposition of the point and line spread functions, shown as line 1540, does not result in a substantially increased effective width of the conductor 915. Accordingly, the visibility of the conductor 915 may be reduced by the arrangement of the light-turning features 920a-d.

For regions of the light guide 910 that are farther away from a conductor 915, the light-turning features 920a-d will each have their own point spread functions. The superposition of these individual point spread functions may be considered to provide a baseline level of optical obscuration or optical density. Once a conductor 915 is added in a particular region, the optical obscuration around the conductor 915 increases, and the conductor is visible. By providing for a relatively low density of light-turning features 920a-d in the regions immediately surrounding a conductor 915, the line spread function of the conductor 915 overlaps sufficiently little with those of the surrounding light-turning features 920a-d to make the optical density of the conductor 915 similar to that of the baseline optical density around and provided by the farther away light-turning features, such as light-turning features that are outside of the line spread function of the conductor 915.

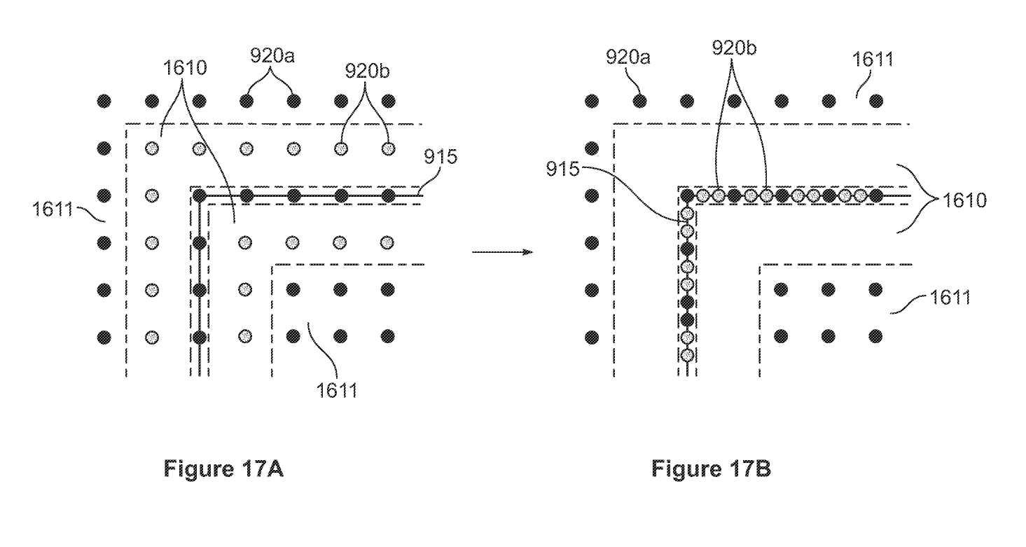

As shown in FIGS. 17A-B, the otherwise locally uniform distribution of light-turning features may be modified by relocating a portion of those light-turning features closest to the conductor onto the conductor itself. Relocating the light turning features 920b on the conductor 915 has the benefit of reducing the optical density of the combination of the conductor 915 and the light turning features 920b, while preserving the light turning capabilities of the light guide 910 in which the light turning features 920b are disposed. Because the light turning features 920b are still present in the light guide 910, the light guide 910 will turn roughly the same amount of light to a display 810 (FIGS. 9A-12B), since the amount of light turned is roughly proportional to the number of the light turning features 920b, which has not changed in number by their relocation. Thus, the illumination function of the light guide 910 is substantially unchanged. In some other implementations, no light turning features 920b are present on the conductor 915. Rather, the light turning features 920b are relocated so that an open region, free of the light turning features 920b, is present around the conductor 915.

FIGS. 17A and 17B show examples of illustrations of a plan view of a portion of a light guide with a conductor surrounded by light-turning features. In FIG. 17A, the conductor 915 is surrounded by an array of light-turning features 920a and 920b. The light-turning features 920b are arranged in a first region 1610 directly adjacent to the conductor 915, while the other light-turning features 920a are arranged in a second region 1611 adjacent to the first region and further from the conductor 915. FIG. 17B illustrates the portion of the light guide after light-turning features 920b positioned in the first region in FIG. 17A have been instead relocated as overlapping and integrated with the conductor 915. Relocating those light-turning features 920b on the conductor 915 results in lower total obscuration around the conductor 915. Following relocation, the region 1610 directly adjacent to the conductor 915 no longer contains light-turning features, in some implementations. In other implementations, some light-turning features are present, although at a lower density than in the second region 1611. The optical density in the region 1610 is therefore decreased. There is less overlap between the line spread function of the conductor 915 and the point spread functions of the nearest light-turning features 920a. The decreased optical density in the region 1610 immediately adjacent to the conductor 915 decreases the perceived contrast between the conductor 915 and the surrounding array of light-turning features 920a, thereby effectively hiding the conductor 915 within the array. Those light-turning features 920b that are relocated onto the conductor 915 itself do not contribute significant additional optical density, as discussed herein. Providing a width of the first region 1610 that lies within the line spread function of the conductor 915 allows for some overlap of the respective point spread functions of all features on the light guide. This in turn provides a baseline level of obscuration which decreases contrast, and therefore visibility, of the conductor 915. As can be seen in FIGS. 17A and 17B, the density of light-turning features 920a-b in the first region surrounding the conductor 915 is much lower than the density of light-turning features 920a-b in the second region adjacent to the first region and further from the conductor 915. This configuration utilizes two phenomena to decrease visibility of the conductor 915: reducing total obscuration by forming light-turning features 920b onto the conductor 915, and reducing overlap of the line and point spread functions of the conductor 915 and the nearest light-turning features 920a.

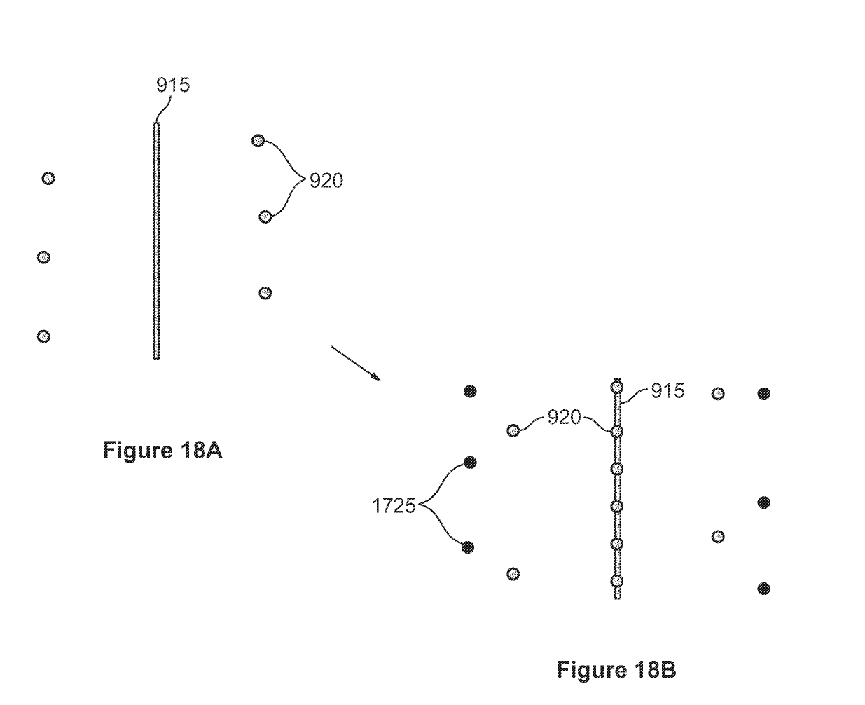

FIGS. 18A and 18B show examples of a plan view of a portion of a light guide with a conductor surrounded by light-turning features and dummy light-turning features. In certain implementations, the surrounding array of light-turning features 920a may be of such low density that the conductor 915 remains distinctly visible even after relocating the nearest light-turning features 920a to be aligned with the conductor 915. In this scenario, dummy light-turning features 1725 may be added to the array of light-turning features. Dummy light-turning features 1725 are objects that obscure light (as seen by a viewer) similar to the light-turning features 920a, but that are not specifically configured to redirect light down towards the display 810 (FIGS. 9A-12B). For example, they may be light obscuring or blocking structures formed flat against the planar top surface of a light guide. For example, the dummy light-turning features 1725 may be patterned from the same layer of material used to metalize the light-turning features 920a and to form the conductor 915. The presence of these dummy light-turning features 1725 effectively raises the background optical density of the array of light-turning features 920a, thereby decreasing the contrast between the optical density of the conductor 915 and that of the surrounding array. As discussed above, visual perception depends both on angular (and corresponding spatial) resolution as well as the contrast ratio. By raising the background optical density through the use of dummy light-turning features 1725, the visibility of the conductor 915 may be reduced.

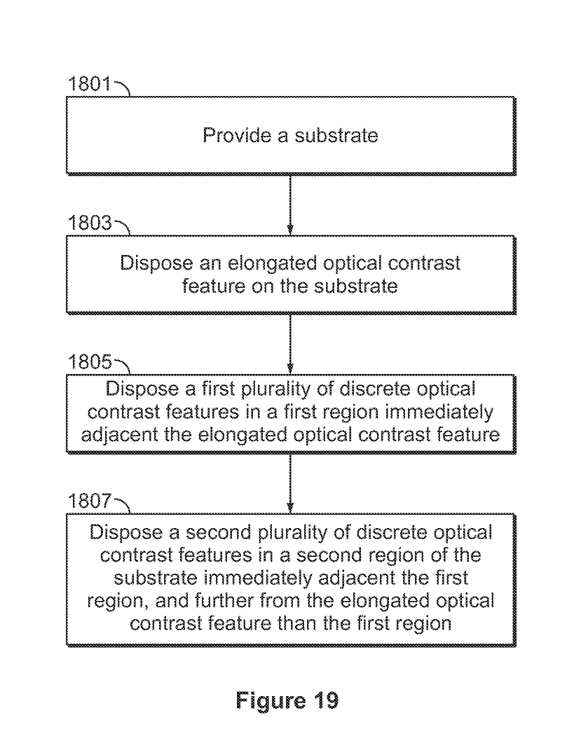

FIG. 19 illustrates an example of a flow diagram of a method for arranging a plurality of discrete optical contrast features on a substrate so as to minimize visibility of one or more elongate optical contrast features. Block 1801 describes providing a substrate, which can be a light guide, such as the light guide 910 (see, for example, FIG. 16A). The substrate may be, for example, a translucent material such as a translucent glass or plastic, or other body of material that can support optical contrast features. In implementations involving optical contrast features that are dark the substrate may have a light appearance. In other implementations, the optical contrast features may be bright, in which case the substrate may itself be dark. Block 1803 describes disposing an elongated optical contrast feature on the substrate. In certain implementations, the elongated optical contrast feature may be a wire formed on a transparent substrate. Such a wire may be formed from a deposited blanket layer of material (such as a layer of a metal) using standard lithographic techniques, including mask formation and etching of the blanket layer to form the wire. However, the elongated optical contrast feature may be virtually any material that provides an optical contrast to the substrate. For example, if the substrate were dark, the elongated optical contrast feature may be a thin strip of white material. In some implementations, the substrate may be etched to form grooves on the substrate surface and material can be deposited and patterned to form the elongated optic contrast features in those grooves. Block 1805 describes disposing a plurality of discrete optical contrast features in a first region immediately adjacent the elongated optical contrast feature. In implementations involving a wire formed on a transparent substrate, the discrete optical contrast features may include light-turning features, such as metalized light-turning features, including metalized recesses, formed in the surface of the substrate. The discrete optical contrast features may, however, be virtually any material that provides an optical contrast to the substrate, including printed dots or other electronic components. As with the elongated optical contrast feature, the discrete optical contrast features may be white or light material in implementations including dark substrates, or vice versa (dark material in implementations including light substrates). As noted above, the material provides for an optical contrast against the substrate. The discrete optical contrast features may be made of the same material as the elongated optical contrast feature. In other implementations, the discrete optical contrast features may be made of a different material, so long as they both provide contrast against the substrate. In implementations involving transparent or semi-transparent substrates, the discrete optical contrast features may be formed below the surface of the substrate, such that they are formed on a layer beneath the elongated optical contrast features. In other implementations, whether with transparent or opaque substrates, the elongated optical contrast feature and discrete optical contrast features may be formed on the same layer or surface. In some implementations, the block 1805 may be omitted, such that no discrete optical contrast features are disposed in the first region.

Block 1807 describes disposing a second plurality of discrete optical contrast features in a second region of the substrate. The second region is adjacent to the first region and further from the elongated optical contrast feature than the first region. In some implementations, the elongated optical contrast feature may be centered within the first region, with the second region adjacent to the first region on either side. The discrete optical contrast features may each be identical structures, or in other implementations their structure may vary. For example, some discrete optical contrast features may be metalized recesses, while others may be dummy light-turning features, such as flat portions of metal deposited on a surface of the substrate. The density of the discrete optical contrast features is higher in the second region than in the first region. For example, the density of discrete optical contrast features in the first region may be between about 0.05% and about 1%, between about 0.05% and about 0.5%, or between about 0.1% and about 0.5%, while the density in the second region may be between about 0.5% and about 10%, between about 0.75% and 7.5%, or between about 1% and about 5%. It will be understood that higher densities can block more light and could reduce the brightness of a front light into which the optical contrast features are integrated. In applications in which reductions in brightness are tolerated, higher densities of discrete optical contrast features may also be tolerated in either or both of the first and second regions. By providing for a relatively lower density of discrete optical contrast features in the first region immediately adjacent the elongated optical contrast feature, the individual point spread functions of the discrete optical contrast features will overlap less with the line spread function of the elongated optical contrast features and the optical density of the optical contrast features will be more uniform across the substrate. As described herein, overlapping spread functions may increase the visibility of a feature by creating a greater optical density in the area around the feature. Accordingly, the lower density of optical contrast features in the first region may reduce visibility of the elongated optical contrast feature. In some implementations for display applications with an intended viewing distance of about 16 inches, the first region has a width that extends from each side of the elongated optical contrast feature by between about 200 microns and about 800 microns. In other implementations, the first region has a width that extends from each side of the elongated optical contrast feature by between about 150 and about 300 microns. In some implementations, a boundary between the first region and the second region defines a line that is spaced from the elongated optical contrast feature at a substantially uniform distance along the length of the elongated optical contrast feature. In some other implementations, this boundary may define a line that varies in spacing from the elongated optical contrast feature along its length.

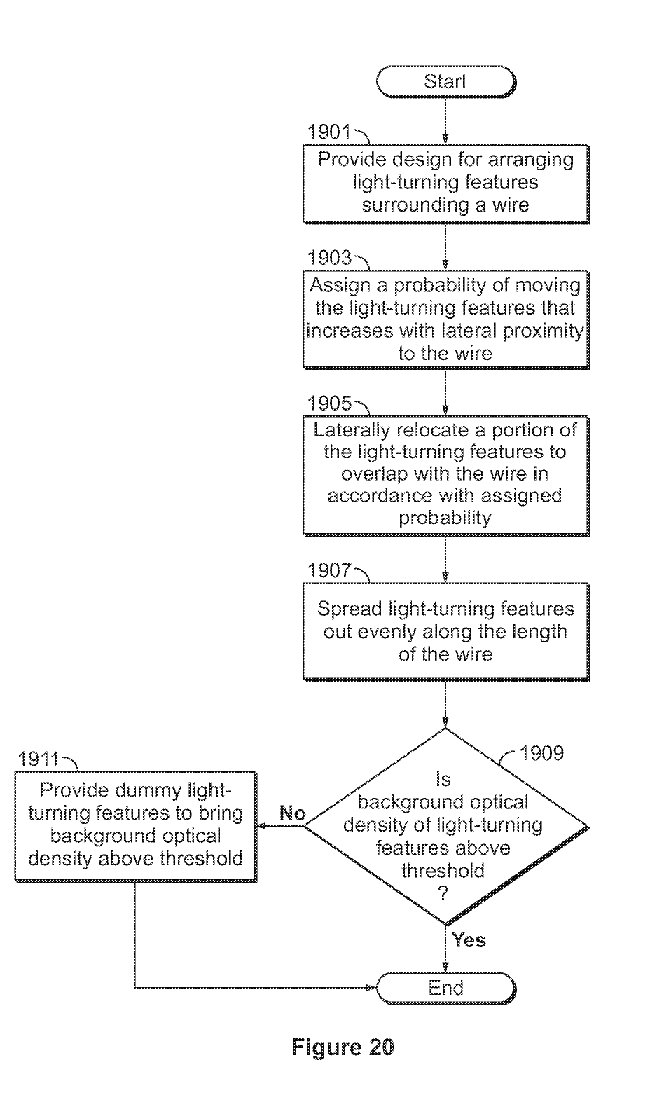

FIG. 20 illustrates a flow diagram of an example of a method for designing the arrangement of light-turning features and dummy light-turning on a substrate so as to reduce visibility of an elongated optical contrast feature. Block 1901 describes providing a design for arranging light-turning features surrounding a wire. For example, the design may include a wire positioned on a substrate in accordance with the requirements of an electronic touch-sensor system, such as in a grid. The design may include the arrangement of light-turning features configured to produce a desired illumination of a display underneath the substrate. For example, the design may arrange light-turning features with increasing density from a light source positioned at one side of the substrate, in order to provide for uniform illumination of the display. Block 1903 describes assigning a probability of moving the light-turning features that increases with lateral proximity to the wire. For example, light-turning features arranged closest to the wire in the design will be assigned the highest probability of being moved. The probability assigned may vary linearly with distance from the wire, or may follow a non-linear pattern. In certain implementations, the probability may vary in accordance with a line spread function of the wire. Block 1905 describes laterally relocating a portion of the light-turning features to overlap with the wire in accordance with the assigned probability. For example, for light-turning features assigned a 50% probability in block 1903, half of the light-turning features will be relocated in the design. The light-turning features may be moved directly laterally in a direction normal to the wire until they overlap with the wire. Block 1907 describes spreading out those light-turning features that have been moved onto the wire so that they are evenly spaced along the length of the wire. Alternatively, in other implementations the light-turning features that have been moved onto the wire may be distributed along the length of the wire in a non-uniform fashion. In certain implementations, the method may terminate after block 1907, and the design may be considered completed. This design may be used to manufacture substrates with an arrangement of light-turning features and wires which may reduce visibility of the wire due to the decreased density of light-turning features in the region closest to the wire.

At block 1909, it is determined whether the background optical density of light-turning features is above a threshold. The threshold may be selected on the basis of empirical or theoretical considerations regarding the background optical density required to reduce visibility of the wire. If the background optical density has been reached, the process may be completed, and, as noted above, the design may be used to manufacture substrates with light-turning features and wires with the prescribed arrangements. If the background optical density has not been reached, the design may be modified by disposing dummy light-turning features on the substrate in sufficient numbers that the desired threshold background optical density is reached.

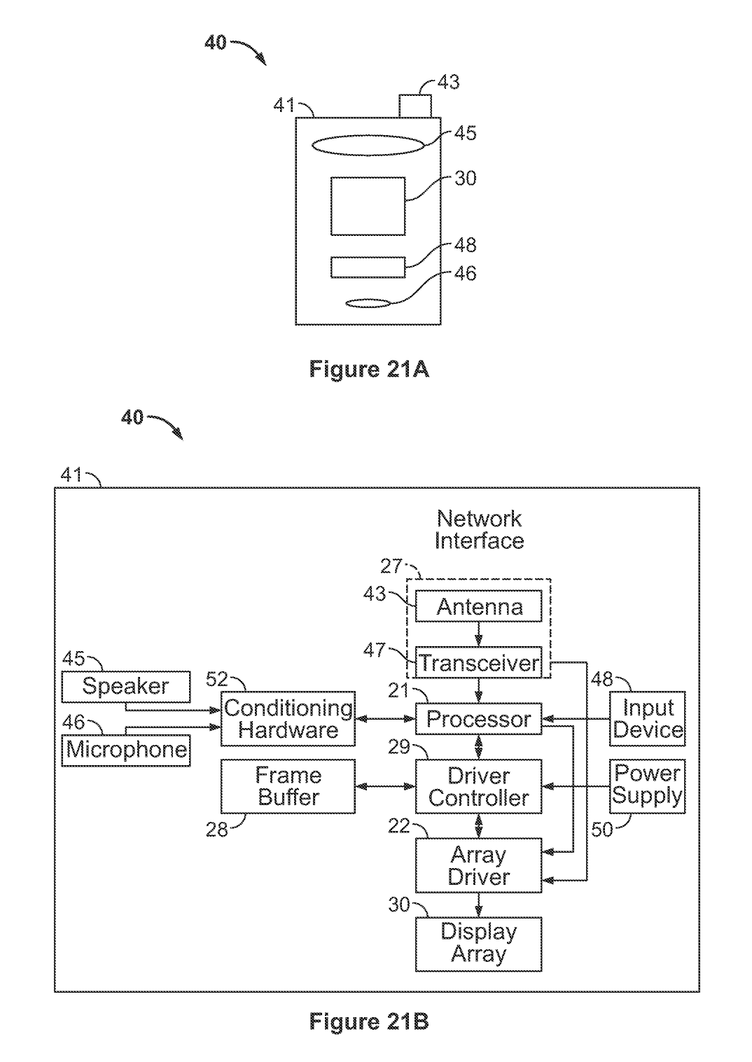

FIGS. 21A and 21B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein. The display 30 may be fabricated using any of the processes and methods disclosed herein. The display 30 may be packaged with an illumination device similar to those disclosed above in reference to FIGS. 9-12 for illuminating the display. In implementations where the display 30 is an interferometric modulator display, the light-turning stack 110 can be part of a front light as shown in FIGS. 11 and 12, or a backlight. More generally, light-turning stack 110 can be part of either a front or backlight.

The components of the display device 40 are schematically illustrated in FIG. 21B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (for example, filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with display array 30, or a pressure- or heat-sensitive membrane. In some implementations, the touch-sensitive screen is integrated with a light guide and includes a touch-sensing electrode array connected to touch-sensing electronics. In some implementations, light-turning features 920b for turning light that is guided in the light guide out of the light guide are located onto one or more conductors (wires) that are part of the touch-sensing electrode array. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blue-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other possibilities or implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of an IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device comprising:
a substrate assembly including:
an elongated optical contrast feature on a substrate;
a first region immediately adjacent the elongated optical contrast feature;
a second region, immediately adjacent the first region and further from the elongated optical contrast feature than the first region;
a first plurality of discrete optical contrast features distributed in the first region;
a second plurality of discrete optical contrast features distributed in the second region;
wherein a first density of the first plurality of discrete optical contrast features is lower than a second density of the second plurality of discrete optical contrast features.

2. The device of claim 1, wherein a boundary between the first region and the second region is spaced from the elongated optical contrast feature at a substantially uniform distance along the length of the elongated optical contrast feature.

3. The device of claim 1, wherein the elongated optical contrast feature is a wire.

4. The device of claim 3, wherein the wire is an electrode that is electrically connected to a touch sensor system configured to sense the proximity of a conductive body and the electrode is part of the touch sensor system.

5. The device of claim 3, wherein a plurality of recesses are formed along the length of the wire, and wherein the wire is at least partially formed of a metal coating the recesses.

6. The device of claim 1, wherein the first region falls substantially entirely within the line spread function of the elongated optical contrast feature for a human eye at a distance of approximately 16 inches.

7. The device of claim 1, wherein the substrate includes a light guide having a major top surface and a major bottom surface, and wherein the discrete optical contrast features include light-turning features configured to turn light propagating within the light guide such that the turned light exits the light guide through the bottom major surface.

8. The device of claim 7, wherein the discrete optical contrast features further include a plurality of dummy light-turning features distributed in the second region.

9. The device of claim 7, wherein the discrete optical contrast features include recesses extending into the top major surface of the light guide.

10. The device of claim 9, wherein the elongated optical contrast feature is formed on the top major surface of the light guide.

11. The device of claim 9, wherein at least some of the recesses are coated with metal.

12. The device of claim 1, further comprising:
a display, wherein the substrate includes a light guide configured for illuminating the display;
a processor that is configured to communicate with the display, the processor being configured to process image data; and
a memory device that is configured to communicate with the processor.

13. The device of claim 12, further comprising:
a driver circuit configured to send at least one signal to the display.

14. The device of claim 13, further comprising:
a controller configured to send at least a portion of the image data to the driver circuit.

15. The device of claim 12, further comprising:
an image source module configured to send the image data to the processor.

16. The device of claim 15, wherein the image source module includes at least one of a receiver, transceiver, and transmitter.

17. The device of claim 12, further comprising:
an input device configured to receive input data and to communicate the input data to the processor, the input device including a touch sensor wherein the elongated optical contrast feature is a wire that is part of the touch sensor.

18. A device comprising:
a substrate assembly including:
an elongated optical contrast feature on a substrate; and
means for obscuring the elongated optical contrast feature.

19. The device of claim 18, wherein the means for obscuring the elongated optical contrast feature includes:
a first region centered around the elongated optical contrast feature;
a second region, immediately adjacent the first region and further from the elongated optical contrast feature than the first region;
a first plurality of discrete optical contrast features distributed in the first region;
a second plurality of discrete optical contrast features distributed in the second region;
wherein a first density of the first plurality of discrete optical contrast features is lower than a second density of the second plurality of discrete optical contrast features.

20. The device of claim 19, wherein the elongated optical contrast feature includes a wire, wherein the wire is an electrode that is electrically connected to a touch sensor system configured to sense the proximity of a conductive body and the electrode is part of the touch sensor system.

21. The device of claim 19, wherein the discrete optical contrast features include recesses formed in the substrate.

22. The device of claim 21, wherein at least some of the recesses are coated with metal.

23. The device of claim 19, wherein the first region falls within the line spread function of the elongated optical contrast feature for a human eye at a distance of approximately 16 inches.

24. The device of claim 20, wherein a plurality of recesses are formed along the length of the wire, and wherein the wire is at least partially formed of a metal coating the recesses.

25. A method of manufacturing a device, the method comprising:
providing a substrate;
providing an elongated optical contrast feature on the substrate;
providing a first plurality of discrete optical contrast features in a first region of the substrate immediately adjacent the elongated optical contrast feature;
providing a second plurality of discrete optical contrast features in a second region of the substrate immediately adjacent the first region and further from the elongated optical contrast feature than the first region,
wherein a first density of the first plurality of discrete optical contrast features is lower than a second density of the second plurality of discrete optical contrast features.

26. The method of claim 25, wherein providing the elongated optical contrast feature includes forming a wire on the substrate.

27. The method of claim 25, wherein providing the first and second pluralities of discrete optical contrast features includes forming recesses on a top surface of the substrate.

28. The method of claim 27, further comprising coating the surfaces of at least some of the recesses formed on the top surface of the substrate with metal.

29. The method of claim 25, wherein the first region falls within the line spread function of the elongated optical contrast feature for a human eye at a distance of approximately 16 inches.

30. The method of claim 26, further comprising electrically connecting the wire to a touch sensor system capable of sensing the proximity of a conductive body and the electrode is part of the touch sensor system.

31. The device of claim 26, wherein forming the wire includes:
forming a plurality of recesses along the length of the wire; and
coating the recesses with metal.
